(19) United States
(12) Patent Application Publication
(10) Pub. No.: US 2013/0326882 A1
(43) Pub. Date: Dec. 12, 2013

(54) HAND TOOL INCLUDING A WIRE STRIPPERS

(71) Applicant: Milwaukee Electric Tool Corporation, Brookfield, WI (US)

(72) Inventor: Kyle Harvey, Wauwatosa, WI (US)

(21) Appl. No.: 13/912,100

(22) Filed: Jun. 6, 2013

Related U.S. Application Data
(60) Provisional application No. 61/656,287, filed on Jun. 6, 2012.

(51) Int. Cl. H02G 1/12

(52) U.S. Cl. CPC H02G 1/1214
USPC 30/91.2

(57) ABSTRACT

A hand tool includes a first member having a first body portion and a first blade portion coupled to the first body portion. The first body portion has a grip. The first blade portion has a U-shaped cutting blade. The hand tool also includes a second member pivotally coupled to the first member for movement between an open position and a closed position. The second member includes a second body portion and a second blade portion coupled to the second body portion. The second body portion has a grip. The second blade portion has a U-shaped cutting blade. The grip of the second body portion includes an annular projection defining an aperture configured to receive a finger of a user.

### CROSS-REFERENCE TO RELATED APPLICATIONS

This application claims priority to U.S. Provisional Patent Application No. 61/656,287, filed Jun. 6, 2012 and titled “HAND TOOL INCLUDING A WIRE STRIPPERS,” the entire contents of which are incorporated by reference herein.

### BACKGROUND

The present invention relates to hand tools, and more particularly to hand tools including wire strippers.

Wire strippers are a known type of hand tool. Such tools typically include scissor-like mechanisms with elongated handles. These tools, however, can be relatively large and bulky, making them difficult to manipulate and operate in tight places (e.g., between wall boards, studs, or joists).

### SUMMARY

In one embodiment, the invention provides a hand tool including a first member having a first body portion and a first blade portion coupled to the first body portion. The first body portion has a grip. The first blade portion has a U-shaped cutting blade. The hand tool also includes a second member pivotally coupled to the first member for movement between an open position and a closed position. The second member includes a second body portion and a second blade portion coupled to the second body portion. The second body portion has a grip. The second blade portion has a U-shaped cutting blade. The grip of the second body portion includes an annular projection defining an aperture configured to receive a finger of a user.

In another embodiment, the invention provides a hand tool including a first member having a first body portion and a first blade portion coupled to the first body portion. The first body portion has a grip. The first blade portion has a U-shaped cutting blade. The hand tool also includes a second member having a second body portion and a second blade portion coupled to the second body portion. The second body portion has a grip. The second blade portion has a U-shaped cutting blade. The second member is pivotally coupled to the first member at a pivot axis for movement between an open position and a closed position. The grip of the first body portion is located between the U-shaped cutting blade of the first blade portion and the pivot axis. The grip of the second body portion is located between the U-shaped cutting blade of the second blade portion and the pivot axis.

In yet another embodiment, the invention provides a hand tool including a first member having a first body portion and a first blade portion coupled to the first body portion. The first body portion has a grip. The first blade portion has a linear cutting blade, a plurality of U-shaped cutting blades, and a tip. The hand tool also includes a second member having a second body portion and a second blade portion coupled to the second body portion. The second body portion has a grip. The second blade portion has a linear cutting blade, a plurality of U-shaped cutting blades, and a tip. The grip of the first body portion includes a generally linear edge configured to rest in a palm of a user. The grip of the second body portion includes an annular projection defining an aperture configured to receive a finger of the user. The second member is pivotally coupled to the first member at a pivot axis for movement between an open position and a closed position. The linear edge of the first body portion is located between the tip of the first blade portion and the pivot axis. The annular projection of the second body portion is located between the tip of the second blade portion and the pivot axis.

### BRIEF DESCRIPTION OF THE DRAWINGS

FIG. 1 is a perspective view of a hand tool according to an embodiment of the invention illustrating the hand tool in a closed position.

FIG. 2 is a side view of the hand tool of FIG. 1 illustrating the hand tool in an open position.

FIG. 3 is a perspective view of a hand tool according to another embodiment of the invention illustrating the hand tool in a closed position.

FIG. 4 is a side view of the hand tool of FIG. 3 illustrating the hand tool in an open position.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

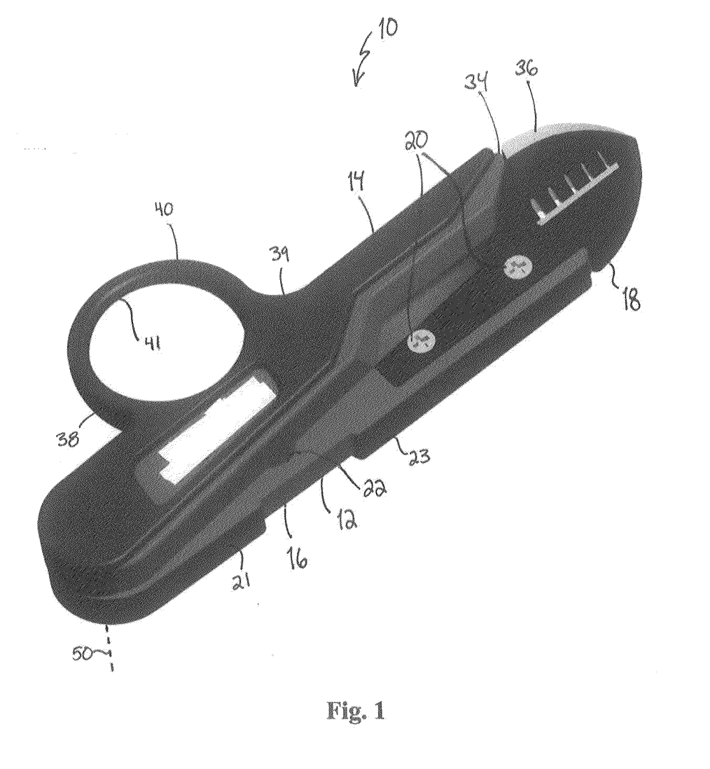

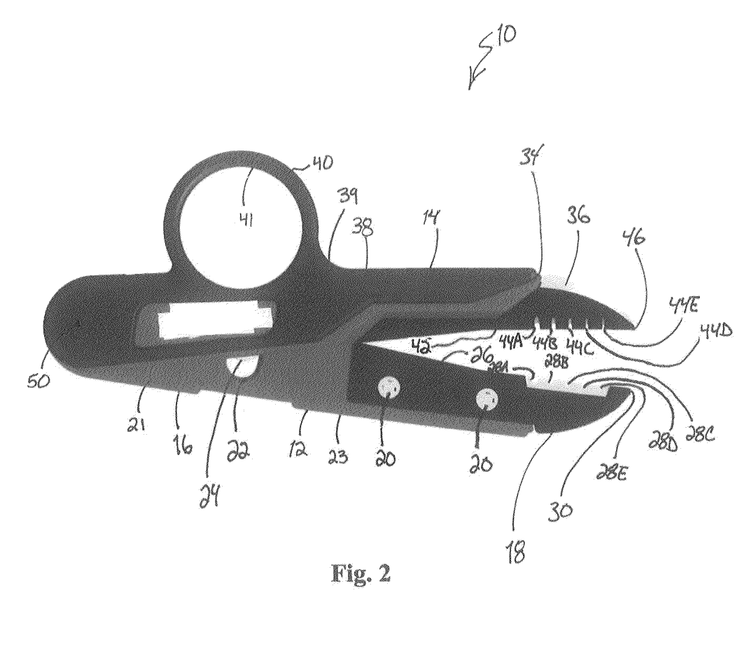

FIG. 1 illustrates a hand tool 10. The hand tool 10 includes a first member 12 pivotally coupled to a second member 14. In one embodiment, the hand tool 10 includes a biasing member that rotationally biases the first member 12 with respect to the second member 14 about the point at which the members 12 and 14 are pivotally coupled to bias the hand tool 10 toward the open position (FIG. 2). Also, in one embodiment, the hand tool 10 includes a latch or the like to inhibit the first member 12 from rotating with respect to the second member 14 about the point at which the members 12 and 14 are pivotally coupled to hold the hand tool 10 in the closed position (FIG. 1).

The first member 12 includes a body portion 16 and a blade portion 18. In the illustrated embodiment, the blade portion 18 is coupled to the body portion 16 via fasteners 20, which are screws in the illustrated embodiment. In other embodiments, other types of fasteners can be used, including adhesives, welding, molding, and the like. In the illustrated embodiment, the body portion 16 is formed from plastic but in other embodiments, other types of materials can be used. Also, the body portion 16 can include an elastomeric overmolding to provide the user with a place to grip the tool 10.

The body portion 16 includes a grip 21 configured to be grasped by a user to facilitate handling and operating the tool 10. In the illustrated embodiment, the grip 21 includes a generally linear edge 23 configured to be received in a palm of a user's hand.

The body portion 16 further includes an elongated aperture 22. The aperture 22 receives a pin 24 coupled to the second member 14 to limit the distance the first member 12 can pivot with respect to the second member 14.

The blade portion 18 includes a relatively long, linear cutting blade 26. The blade portion 18 also includes a plurality of generally U-shaped cutting blades 28A, 28B, 28C, 28D, 28E. The blade portion 18 further includes a precision diagonal pliers tip 30. The cutting blades 28A, 28B, 28C, 28D, 28E are located directly between the blade 26 and the tip 30.

The second member 14 includes a body portion 34 and a blade portion 36. In the illustrated embodiment, the blade portion 36 is coupled to the body portion 34 via fasteners, similar to the fasteners 20 of the first member 12, which are screws in one embodiment. In other embodiments, other types of fasteners can be used, including adhesives, welding, molding, and the like. In the illustrated embodiment, the body portion 34 is formed from plastic but in other embodiments, other types of materials can be used. Also, the body portion 34 includes an elastomeric overmolding 38 to provide the user with a place to grip the tool 10.

The body portion 34 includes a grip 39 configured to be grasped by a user to facilitate handling and operating the tool 10. In the illustrated embodiment, the grip 39 includes an annular projection 40 that defines an aperture 41. The aperture 41 is configured to receive a ring finger or a middle finger of a user during operation of the tool 10. The illustrated annular projection 40 forms a closed loop with the body portion 14 to define the aperture 41. In other embodiments, a portion of the annular projection 40 may be open or discontinuous such that a user can radially slide his/her finger into and out of the aperture 41. The illustrated elastomeric overmolding 38 warps entirely around the annular projection 40.

The blade portion 36 includes a relatively long, linear cutting blade 42. The blade portion 36 also includes a plurality of generally U-shaped cutting blades 44A, 44B, 44C, 44D, 44E. The blade portion 36 further includes a precision diagonal pliers tip 46. The cutting blades 44A, 44B, 44C, 44D, 44E are located directly between the blade 42 and the tip 46.

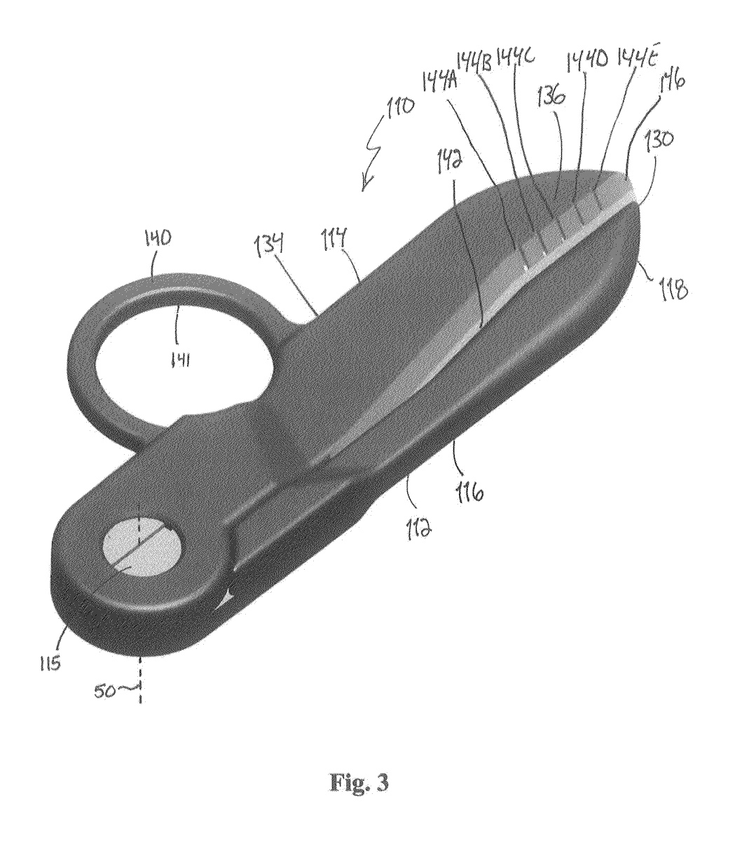

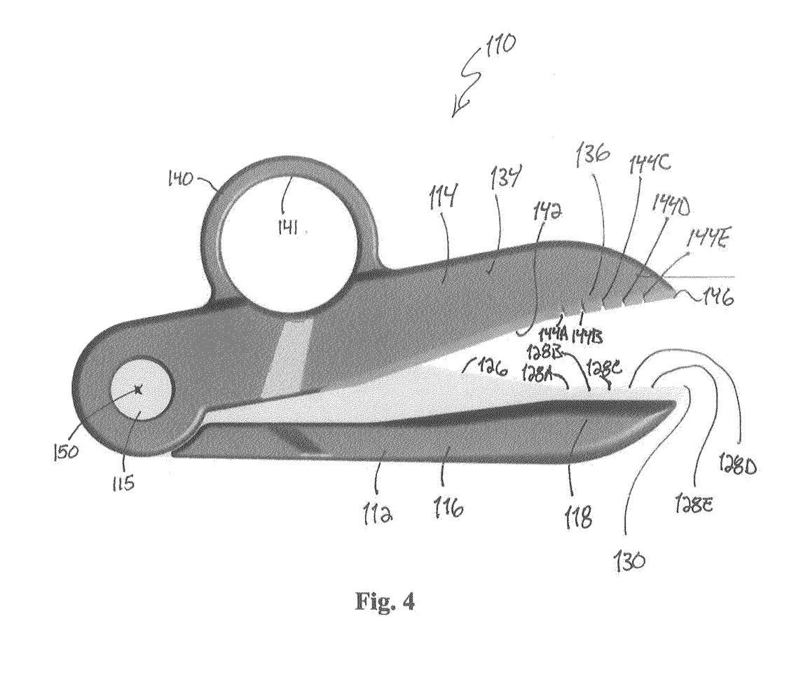

As shown in FIGS. 1-2, the second member 14 is pivotally coupled to the first member 12 at a pivot axis 50 for movement between the open position (FIG. 2) and the closed position (FIG. 1). In some embodiments, the pivot axis 50 is defined by a pin (see FIGS. 3-4) that pivotally couples the members 12, 14 together. The pivot axis 50 is located adjacent an end of the members 12, 14 opposite from the tips 30, 46 of the blade portions 18, 36. In the illustrated embodiment, the grips 21, 39 of the first and second members 12, 14 (and more particularly the annular projection 40 and the generally linear edge 23 of the grips 21, 39) are located between the U-shaped cutting blades 28A, 28B, 28C, 28D, 28E and 44A, 44B, 44C, 44D, 44E of the corresponding blade portions 18, 36 and the pivot axis 50.

In operation, the user places his/her ring finger or middle finger through the aperture 40 and places the first member 12 in his/her palm adjacent his/her thumb, and the user squeezes the first member 12 and the second member 14 to pivot the first member 12 relative to the second member 14. With the members 12 and 14 pivoting with respect to each other, the cutting blades 26 and 42 can be used to cut materials such as wire, cable ties, and the like. Also, the user can use the U-shaped cutting blades 28A, 28B, 28C, 28D, 28E and 44A, 44B, 44C, 44D, 44E to strip insulation from wires. For example, the cutting blades 28A and 44A can be sized and used together to strip insulation from 18 gauge wire. The cutting blades 28B and 44B can be sized and used together to strip insulation from 20 gauge wire. Likewise, the cutting blades 28C and 44C can be used to strip 22 gauge wire, the cutting blades 28D and 44D can be used to strip 24 gauge wire, and the cutting blades 28E and 44E can be used to strip 26 gauge wire. In other embodiments, the cutting blades 28A, 28B, 28C, 28D, 28E and 44A, 44B, 44C, 44D, 44E can be sized to strip any suitable size wire.

Also, the user can pivot the members 12 and 14 to use the precision diagonal pliers tips 30 and 46 to bend wire, crimp wire, rotate wires, and the like.

FIGS. 3-4 illustrate a hand tool 110 according to another embodiment of the invention. The hand tool 110 includes features similar to the hand tool 10 of FIGS. 1-2 and only differences between the hand tools 10 and 110 will be described in detail and like components have been given like reference numbers, plus 100. As discussed above, the hand tool 110 includes the first member 112 and the second member 114 that are pivotally coupled together by a pin 115. In addition, the members 112 and 114 include the blade portions 118 and 136 that are coupled or attached to the respective body portions 116 and 134. In the illustrated embodiment, the blade portion 118 is integrally formed with the body portion 116 as a single component, and the blade portion 136 integrally formed with the body portion 134 as a single component. In one such embodiment, the integral blade and body portions 118 and 116 and the integral blade and body portions 136 and body 134 are formed from metal. Such an embodiment can include rubber or elastomeric overmoldings and the like to insulate the metal blade and body portions and provide the user with a location to grip the hand tool.

Accordingly, the invention provides a hand tool, which can be used by an electrician, to cut, strip, and otherwise manipulate wires. The tool is compact and can easily fit in a user's pocket or tool pouch.

Although the invention has been described with reference to certain preferred embodiments, variations and modifications exist within the scope and spirit of one or more independent aspects of the invention.

Various features and advantages of the invention are set forth in the following claims.

1. A hand tool comprising:
a first member including a first body portion and a first blade portion coupled to the first body portion, the first body portion having a grip, the first blade portion having a U-shaped cutting blade; and
a second member pivotally coupled to the first member for movement between an open position and a closed position, the second member including a second body portion and a second blade portion coupled to the second body portion, the second body portion having a grip, the second blade portion having a U-shaped cutting blade;
wherein the grip of the second body portion includes an annular projection defining an aperture configured to receive a finger of a user.

2. The hand tool of claim 1, wherein the grip of the first body portion includes a generally linear edge configured to rest in a palm of the user.

3. The hand tool of claim 1, wherein the annular projection forms a closed loop that defines the aperture.

4. The hand tool of claim 1, wherein the second member is pivotally coupled to the first member at a pivot axis, and wherein the annular projection is located between the U-shaped cutting blade of the second blade portion and the pivot axis.

5. The hand tool of claim 1, wherein each of the first and second blade portions includes a plurality of U-shaped cutting blades.

6. The hand tool of claim 1, wherein each of the first and second blade portions includes a linear cutting blade and a tip.

7. The hand tool of claim 6, wherein the U-shaped cutting blade of each of the first and second blade portions is located between the linear cutting blade and the tip.

8. The hand tool of claim 6, wherein the tips of the first and second blade portions form a precision diagonal pliers.

9. The hand tool of claim 1, wherein the first blade portion is secured to the first body portion with fasteners, and wherein the second blade portion is secured to the second body portion with fasteners.

10. The hand tool of claim 1, wherein the first blade portion is integrally formed as a single component with the first body portion, and wherein the second blade portion is integrally formed as a single component with the second body portion.

11. A hand tool comprising:
a first member including a first body portion and a first blade portion coupled to the first body portion, the first body portion having a grip, the first blade portion having a U-shaped cutting blade; and
a second member including a second body portion and a second blade portion coupled to the second body portion, the second body portion having a grip, the second blade portion having a U-shaped cutting blade;
wherein the second member is pivotally coupled to the first member at a pivot axis for movement between an open position and a closed position, wherein the grip of the first body portion is located between the U-shaped cutting blade of the first blade portion and the pivot axis, and wherein the grip of the second body portion is located between the U-shaped cutting blade of the second blade portion and the pivot axis.

12. The hand tool of claim 11, wherein the first member defines an elongated aperture, and wherein a portion of the second member extends into the elongated aperture of the first member to limit movement of the second member relative to the first member.

13. The hand tool of claim 12, wherein the elongated slot of the first member is located between the pivot axis and the U-shaped cutting blade of the first blade portion.

14. The hand tool of claim 11, wherein each of the first and second blade portions includes a plurality of U-shaped cutting blades.

15. The hand tool of claim 11, wherein each of the first and second blade portions includes a linear cutting blade and a tip.

16. The hand tool of claim 15, wherein the U-shaped cutting blade of each of the first and second blade portions is located between the linear cutting blade and the tip.

17. The hand tool of claim 15, wherein the tips of the first and second blade portions form a precision diagonal pliers.

18. The hand tool of claim 11, wherein the first blade portion is secured to the first body portion with fasteners, and wherein the second blade portion is secured to the second body portion with fasteners.

19. The hand tool of claim 11, wherein the first blade portion is integrally formed as a single component with the first body portion, and wherein the second blade portion is integrally formed as a single component with the second body portion.

20. A hand tool comprising:
a first member including a first body portion and a first blade portion coupled to the first body portion, the first body portion having a grip, the first blade portion having a linear cutting blade, a plurality of U-shaped cutting blades, and a tip; and
a second member including a second body portion and a second blade portion coupled to the second body portion, the second body portion having a grip, the second blade portion having a linear cutting blade, a plurality of U-shaped cutting blades, and a tip;
wherein the grip of the first body portion includes a generally linear edge configured to rest in a palm of a user, and wherein the grip of the second body portion includes an annular projection defining an aperture configured to receive a finger of the user; and
wherein the second member is pivotally coupled to the first member at a pivot axis for movement between an open position and a closed position, wherein the linear edge of the first body portion is located between the tip of the first blade portion and the pivot axis, and wherein the annular projection of the second body portion is located between the tip of the second blade portion and the pivot axis.
